(19) United States
(12) Patent Application Publication
(10) Pub. No.: US 2013/0046914 A1
(43) Pub. Date: Feb. 21, 2013

(54) CONNECTOR ASSEMBLY

(71) Applicants: Cheng-Fei WENG, Shenzhen City (CN); Zheng-Heng SUN, Tu-Cheng (TW)

(72) Inventors: Cheng-Fei WENG, Shenzhen City (CN); Zheng-Heng SUN, Tu-Cheng (TW)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/284,964

(22) Filed: Oct. 30, 2011

(30) Foreign Application Priority Data
Aug. 17, 2011 (CN) 201110235980.X

(51) Int. Cl. G06F 13/00

(52) U.S. Cl. 710/316

(57) ABSTRACT

A connector assembly includes first to fourth groups of holes set on a motherboard, first and second peripheral component interconnection express (PCIe) slots, and a number of switches. When the second group of holes are connected to the fourth group of holes, the signals at the second group of holes are transmitted to the second group of pins of the second PCIe slot through the switches and the fourth group of holes.

### CROSS-REFERENCE TO RELATED APPLICATIONS

Relevant subject matter is disclosed in a pending U.S. patent application (application Ser. No. 13/274,344, filed on Oct. 16, 2011) having the same title and assigned to the same assignee as named herein.

### BACKGROUND

1. Technical Field

The present disclosure relates to connectors, and particularly, to a peripheral component interconnect express (PCIe) connector assembly.

2. Description of Related Art

Motherboard slots, such as PCIe connectors, are electrical interfaces used for data transmission between a computer and expansion cards, such as graphics cards. Lanes provided by a chipset on the motherboard are distributed to the slots on the motherboard. However, the lane number of lanes is limited in accordance with the capability of the chipset, and the lanes distributed to a particular slot cannot be used by another slot even when the particular slot is not in use. Therefore, there is room to improvement in the art.

### BRIEF DESCRIPTION OF THE DRAWINGS

The components in the drawings are not necessarily drawn to scale, the emphasis instead being placed upon clearly illustrating the principles of a connector assembly. Moreover, in the drawings, like reference numerals designate corresponding parts throughout the several views.

FIG. 1 is an isometric view of a connector assembly in accordance with an exemplary embodiment, the connector assembly including first to fourth groups of holes.

FIG. 2 is a schematic diagram of two holes of the first and fourth groups of holes of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

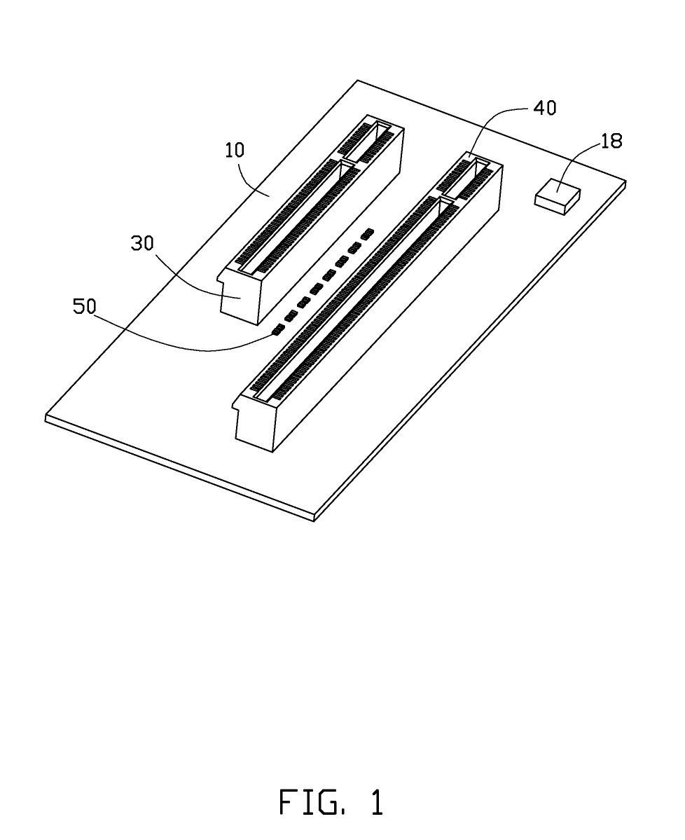

Referring to FIG. 1, a connector assembly is mounted on a motherboard 10. An exemplary embodiment of the connector assembly includes a peripheral component interconnection express (PCIe) x8 slot 30, a PCIe x16 slot 40, a plurality of holes set on the motherboard 10 and coated with copper on inner sidewalls bounding the holes, and a plurality of switches 50.

Standard PCIe slots can include up to 32 PCIe lanes, termed x1, x4, x16, x32 in respect to the number of physical or electrical lanes. In relation to the physical lanes of the slots, the electrical lanes are provided by a chipset 18 on the motherboard 10. A standard PCIe expansion card can be fitted into a standard PCIe slot with more physical lanes, but cannot be fitted into another standard PCIe slot with less physical lanes. Therefore, larger PCIe slots are sometimes preferred for installation on the motherboard 10 for receiving larger PCIe expansion cards while the electrical lanes actually connected to the slot are less than the physical lanes of the slot. For example, when the motherboard 10 capable of providing 20 PCIe lanes is equipped with a PCIe x4 slot, a PCIe x8 slot, and a PCIe x16 slot. The PCIe x16 slot can only acquire 8 electrical lanes for data transmission while the PCIe x4 slot and the PCIe x8 slot are respectively set up with 4 and 8 electrical lanes, and thus limiting the bandwidth of the PCIe x16 slot.

The standard PCIe slot includes a side A and a side B, who have a number of pins respectively corresponding to the physical lanes. A standard PCIe x1 slot has 18 pins on the side A called A1-A18 and 18 pins on the side B called B1-B18, and the first 13 pins on each side (A1-A13 and B1-B13) are for generic usage, such as power and clock. While the other 5 pins (A14-A18 and B14-B18) correspond to a lane called lane 0 for signal transmission. A standard PCIe x4 slot has 15 more pins (on both sides) called A19-A32 and B19-B32 than the standard PCIe x1 slot, and the 15 pins correspond to lane 1 (A19-A22 and B19-B22), lane 2 (A23-A26 and B23-B26), and lane 3 (A27-A32 and B27-B32). A standard PCIe x8 slot has 17 more pins (on both sides) called A33-A49 and B33-B49 than the standard PCIe x4 slot, and the 17 pins correspond to lane 4 (A33-A36 and B33-B36), lane 5 (A37-A40 and B37-B40), lane 6 (A41-A44 and B41-B44), and lane 7 (A45-A49 and B45-B49). A standard PCIe x16 slot has 33 more pins (on both sides) called A50-A82 and B50-B82 than the standard PCIE x8 slot. The 33 pins correspond to lane 8 (A50-A53 and B50-B53), lane 9 (A54-A57 and B54-B57), lane 10 (A58-A61 and B58-B61), lane 11 (A62-A65 and B62-B65), lane 12 (A66-A69 and B66-B69), lane 13 (A70-A73 and B70-B73), lane 14 (A74-A77 and B74-B77), and lane 15 (A78-A82 and B78-B82).

In the embodiment, the chipset 18 provides 16 electrical lanes. The PCIe x8 slot 30 includes 49 pins on the side A called A1-A49, and 49 pins on the side B called B1-B49. The pins A1-A13 and B1-B13 of the PCIe x8 slot 30 are regarded as a first group of pins of the PCIe x8 slot 30. The pins A14-A49 and B14-B49 of the PCIe x8 slot 30 are regarded as a second group of pins of the PCIe x8 slot 30. The PCIe x16 slot 40 includes 82 pins on the side A called A1-A82, and 82 pins on the side B called B1-B82. The pins A1-A49 and B1-B49 of the PCIe x16 slot 40 are regarded as a first group of pins of the PCIe x16 slot 40. The pins A50-A82 and B50-B82 of the PCIe x16 slot 40 are regarded as a second group of pins of the PCIe x16 slot 40. The pins A1-A13 and B1-B13 of the PCIe x8 slot 30 and the PCIe x16 slot 40 are used to receive power and clock signals from the chipset 18. The pins A14-A49 and B14-B49 of the PCIe x8 slot 30 and the PCIe x16 slot 40 are used to connect to the chipset 18 to acquire 8 electrical lanes for data transmission from the chipset 18.

The holes include a first group of holes, a second group of holes, a third group of holes, and a fourth group of holes. The first group of holes includes thirteen holes on a first side called C1-C13, and thirteen holes on a second side called D1-D13. The holes C1-C13 correspond to the pins A1-A13 of the PCIe x8 slot 30. The holes D1-D13 correspond to the pins B1-B13 of the PCIe x8 slot 30. The second group of holes includes thirty-six holes on a first side called C14-C49 and thirty-six holes on a second side called D14-D49. The holes C14-C49 correspond to the pins A14-A49 of the PCIe x8 slot 30. The holes D14-D49 correspond to the pins B14-B49 of the PCIe x8 slot 30. The first and second groups of holes are further connected to the chipset 18. As a result, when the pins of the PCIe x8 slot 30 are plugged into the corresponding holes, the PCIe x8 slot 30 acquires eight electrical lanes for data transmission from the chipset 18.

The third group of holes includes forty-nine holes on a first side called C1-C49 and forty-nine holes on a second side called D1-D49. The holes C1-C49 correspond to the pins A1-A49 of the PCIe x16 slot 40. The holes D1-D49 correspond to the pins B1-B49 of the PCIe x16 slot 40. The fourth group of holes includes thirty-three holes on a first side called C50-C82 and thirty-three holes on a second side called D50-D82. The holes C50-C82 correspond to the pins A50-A82 of the PCIe x16 slot 40. The holes D50-D82 correspond to the pins B50-B82 of the PCIe x16 slot 40. The third and fourth groups of holes are further connected to the chipset 18. As a result, when the pins of the PCIe x16 slot 40 are plugged into the corresponding holes, the PCIe x16 slot 40 acquires eight electrical lanes for data transmission from the chipset 18.

In addition, the second group of holes are connected to the fourth group of holes through wires, correspondingly. A switch 50 is connected on each wire to cut off or connect the wire. Refer to table 1, relationships between each hole of the second and fourth groups of holes are shown.

TABLE 1

| Second | Fourth |
|---|---|
| group | group |
| C14 | C50 |
| C15 | C51 |
| C16 | C52 |
| C17 | C53 |
| C18 | C54 |
| C19 | — |
| C20 | C55 |
| C21 | C56 |
| C22 | C57 |
| C23 | C58 |
| C24 | C59 |
| C25 | C60 |
| C26 | C61 |
| C27 | C62 |
| C28 | C63 |
| C29 | C64 |
| C30 | C65 |
| C31 | C66 |
| C32 | — |
| C33 | — |
| C34 | C67 |
| C35 | C68 |
| C36 | C69 |
| C37 | C70 |
| C38 | C71 |
| C39 | C72 |
| C40 | C73 |
| C41 | C74 |
| C42 | C75 |
| C43 | C76 |
| C44 | C77 |
| C45 | C78 |
| C46 | C79 |
| C47 | C80 |
| C48 | C81 |
| C49 | C82 |
| D14 | D50 |
| D15 | D51 |
| D16 | D52 |
| D17 | — |
| D18 | D53 |
| D19 | D54 |
| D20 | D55 |
| D21 | D56 |
| D22 | D57 |
| D23 | D58 |
| D24 | D59 |
| D25 | D60 |
| D26 | D61 |
| D27 | D62 |
| D28 | D63 |
| D29 | D64 |
| D30 | D65 |
| D31 | D66 |
| D32 | — |
| D33 | — |
| D34 | D67 |
| D35 | D68 |
| D36 | D69 |
| D37 | D70 |
| D38 | D71 |
| D39 | D72 |
| D40 | D73 |
| D41 | D74 |
| D42 | D75 |
| D43 | D76 |
| D44 | D77 |
| D45 | D78 |
| D46 | D79 |
| D47 | D80 |
| D48 | D81 |
| D49 | D82 |

From table 1, in the embodiment, the hole C14 of the second group of holes is connected to the hole C50 of the fourth group of holes, the hole C15 of the second group of holes is connected to the hole C51 of the fourth group of holes, and so on. The holes C19, C32, C33, D17, D32, and D33 are idle.

When a PCIe x16 expansion card is plugged into the PCIe x16 slot 40, and the PCIe x8 slot 30 is idle, the switches 50 on the wires are turned on. At this time, the signals at the second group of holes from the chipset 18 are transmitted to the fourth group of holes, and then to the pins A50-A82 and B50-B82 of the PCIe x16 slot 40. As a result, the pins A1-A49 and B1-B49 of the PCIe x16 slot 40 receive signals from the chipset 18, and the pins A50-A82 and B50-B82 of the PCIe x16 slot 40 receive signals from the chipset 18 through the second group of holes, the wires, and the fourth group of holes in that order. Therefore, the PCIe x16 expansion card plugged into the PCIe x16 slot 40 acquires sixteen electrical lanes for data transmission from the chipset 18.

When the PCIe x16 expansion card is plugged into the PCIe x16 slot 40, and a PCIe x8 expansion card is plugged into the PCIe x8 slot 30, the switches 50 on the wires are turned off. At this time, the PCIe x8 expansion card receives signals from the chipset 18 through the pins A1-A49 and B1-B49 of the PCIe x8 slot 30, and the PCIe x16 expansion card receives signals from the chipset 18 through the pins A1-A49 and B1-B49 of the PCIe x16 slot 40.

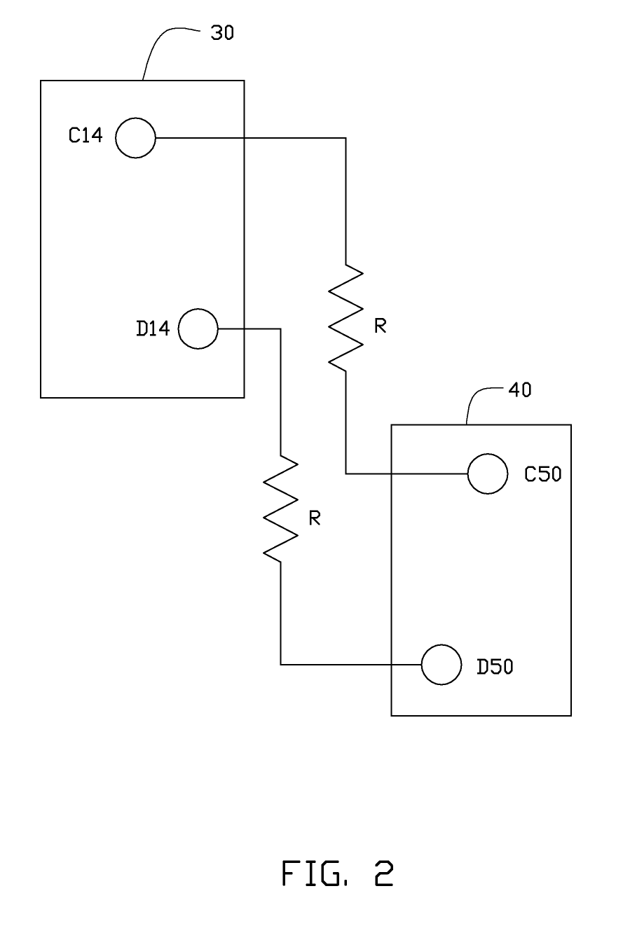

Referring to FIG. 2, it shows how the holes C14 and D14 of the second group of holes are connected to the holes C50 and D50 of the fourth group of holes. In the embodiment, the switch 50 can be replaced by a zero-ohm resistor R. When the PCIe x16 expansion card is plugged into the PCIe x16 slot 40, and the PCIe x8 slot 30 is idle, the zero -ohm resistor R is soldered to each wire. When the PCIe x16 expansion card is plugged into the PCIe x16 slot 40, and the PCIe x8 expansion card is plugged into the PCIe x8 slot 30, the zero-ohm resistor R is removed from each wire.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A connector assembly comprising:
first to fourth groups of holes set on a motherboard and coated with copper on inner sidewalls bounding the holes, wherein the first to third groups of holes are connected to a chipset on the motherboard for receiving signals from the chipset;
a first peripheral component interconnection express (PCIe) slot comprising first and second groups of pins plugged into the first and second groups of holes;
a second PCIe slot comprising third and fourth group of pins plugged into the third and fourth groups of holes; and
a plurality of switches, wherein each switch is connected between a corresponding hole of the second group of holes and a corresponding hole of the fourth group of holes, to connect or disconnect the hole of the second group of holes to or from the hole of the fourth group of holes, the signals at the second group of holes are transmitted to the second group of pins of the second PCIe slot through the switches and the fourth group of holes, in response to the second group of holes being connected to the fourth group of holes by the corresponding switches.

2. The connector assembly of claim 1, wherein the first PCIe slot is a PCIe x8 slot, the first group of pins of the PCIe x8 slot comprise first to thirteen pins on a first side and first to thirteen pins on a second side, the second group of pins of the PCIe x8 slot comprise fourteen to forty-ninth pins on the first side and fourteen to forty-ninth pins on the second side, the first group of holes comprise first to thirteen holes on a first side and first to thirteen holes on a second side, the second group of holes comprise fourteen to forty-ninth holes on the first side and fourteen to forty-ninth holes on the second side, the first and second group of pins of the PCIe x8 slot are plugged into the first and second group of holes correspondingly; the second PCIe slot is a PCIe x16 slot, the third group of pins of the PCIe x16 slot comprise first to forty-ninth pins on a first side and first to forty-ninth pins on a second side, the fourth group of pins of the PCIe x16 slot comprise fiftieth to eighty-second pins on the first side and fiftieth to eighty-second pins on the second side, the third group of holes comprise first to forty-ninth holes on a first side and first to forty-ninth holes on a second side, the fourth group of holes of the PCIe x16 slot comprise fiftieth to eighty-second holes on the first side and fiftieth to eighty-second holes on the second side, the third and fourth group of pins of the PCIe x16 slot are plugged into the third and fourth group of holes correspondingly; the first to fifth holes, the seventh to eighteenth holes, and the twentieth to thirty-sixth holes on the first side of the second group of holes are connected to the first to thirty-third holes on the first side of the fourth group of holes through the corresponding switches, the first to third holes, the fifth to sixteenth holes, the nineteenth holes to the thirty-sixth holes on the second side of the second group of holes are connected to the first to thirty-third holes on the second side of the fourth group of holes through the corresponding switches.

3. A connector assembly comprising:
first to fourth groups of holes set on a motherboard and coated with copper on inner sidewalls bounding the holes, wherein the first to third groups of holes are connected to a chipset on the motherboard for receiving signals from the chipset;
a first peripheral component interconnection express (PCIe) slot comprising first and second groups of pins plugged into the first and second groups of holes;
a second PCIe slot comprising third and fourth group of pins plugged into the third and fourth groups of holes; and
a plurality of zero-ohm resistors, wherein each zero-ohm resistor is soldered or de-soldered between a corresponding hole of the second group of holes and a corresponding hole of the fourth group of holes, to connect or disconnect the hole of the second group of holes to or from the hole of the fourth group of holes, the signals at the second group of holes are transmitted to the second group of pins of the second PCIe slot through the zero-ohm resistors and the fourth group of holes, in response to the second group of holes being connected to the fourth group of holes by the corresponding zero-ohm resistor.

4. The connector assembly of claim 3, wherein the first PCIe slot is a PCIe x8 slot, the first group of pins of the PCIe x8 slot comprise first to thirteen pins on a first side and first to thirteen pins on a second side, the second group of pins of the PCIe x8 slot comprise fourteen to forty-ninth pins on the first side and fourteen to forty-ninth pins on the second side, the first group of holes comprise first to thirteen holes on a first side and first to thirteen holes on a second side, the second group of holes comprise fourteen to forty-ninth holes on the first side and fourteen to forty-ninth holes on the second side, the first and second group of pins of the PCIe x8 slot are plugged into the first and second group of holes correspondingly; the second PCIe slot is a PCIe x16 slot, the third group of pins of the PCIe x16 slot comprise first to forty-ninth pins on a first side and first to forty-ninth pins on a second side, the fourth group of pins of the PCIe x16 slot comprise fiftieth to eighty-second pins on the first side and fiftieth to eighty-second pins on the second side, the third group of holes comprise first to forty-ninth holes on a first side and first to forty-ninth holes on a second side, the fourth group of holes of the PCIe x16 slot comprise fiftieth to eighty-second holes on the first side and fiftieth to eighty-second holes on the second side, the third and fourth group of pins of the PCIe x16 slot are plugged into the third and fourth group of holes correspondingly; the first to fifth holes, the seventh to eighteenth holes, and the twentieth to thirty-sixth holes on the first side of the second group of holes are connected to the first to thirty-third holes on the first side of the fourth group of holes through the corresponding zero-ohm resistors, the first to third holes, the fifth to sixteenth holes, the nineteenth holes to the thirty-sixth holes on the second side of the second group of holes are connected to the first to thirty-third holes on the second side of the fourth group of holes through the corresponding zero-ohm resistors.
